(19) United States
(12) Patent Application Publication
(10) Pub. No.: US 2025/0285179 A1
(43) Pub. Date: Sep. 11, 2025

(54) ASYNCHRONOUS LOAN DATA STRUCTURE ORIGINATION

(71) Applicant: American Express Travel Related Services Company, Inc., New York, NY (US)

(72) Inventors: Aditya YALLATURU, New York, NY (US); Siva Kumar EDUPUGANTI, Phoenix, AZ (US); Jill Marie BARTHOLOMEW, Downingtown, PA (US)

(73) Assignee: American Express Travel Related Services Company, Inc., New York, NY (US)

(21) Appl. No.: 18/601,158

(22) Filed: Mar. 11, 2024

(51) Int. Cl. G06Q 40/03; G06Q 20/10; G06Q 20/40

(52) U.S. Cl. CPC G06Q 40/03; G06Q 20/10; G06Q 20/4037

(57) ABSTRACT

Disclosed herein are system, method, and computer program product embodiments for asynchronous loan data structure origination. An account management system may receive from a point of sale system, transaction data and a request for authorizing a transaction. In response to receiving the transaction data, the account management system may determine that a difference between a transaction value and an account balance is less than a line of credit parameter. In response to the determining, the account management system may transmit, to the point of sale system, an authorization message indicating that the transaction is authorized. The account management system may also automatically trigger an asynchronous loan origination process to create a loan data structure for a loan balance corresponding to the difference. The asynchronous loan origination process occurs independently from transmitting the authorization message to the point of sale system.

### TECHNICAL FIELD

Aspects relate to systems and methods for triggering an asynchronous loan data structure origination process.

### BACKGROUND

A customer may use a checking account or a debit card for a proposed payment at a merchant. However, the customer may not realize that an overdraft has taken place (e.g., exception hold on a check). The customer may be charged with high fees due to the overdraft. In other examples, the proposed payment may be rejected by an issuer of the debit card that leads to the abandonment of a sale transaction associated with the proposed payment. In addition, customers enjoy the benefits and advantages of a credit card (e.g., no risk of overdraft, flexibility of repayment of the balance). However, credit card payments are not accepted by all merchants. In addition, credit card payments may not be accepted for rent or mortgage payments or for payment of utility bills. A customer may obtain fund for such transactions through traditional loans. However, such transactions suffer from the technical challenge of receiving authorizations in a timely fashion. Another technical challenge relates to dealing with sheer volumes of transaction requests that may increase the number of errors and failed transactions.

### SUMMARY

Disclosed herein are system, apparatus, device, method and/or computer program product embodiments, and/or combinations and sub-combinations thereof, for asynchronous loan data structure origination.

In some embodiments, an account management system may receive from a point of sale system, transaction data and a request for authorizing a transaction. The transaction data may comprise information identifying an account and a transaction value. The account may be associated with a user. In response to receiving the transaction data, the account management system may determine that a difference between the transaction value and an account balance associated with the account is less than a line of credit parameter associated with the account. In response to the determining, the account management system may transmit, to the point of sale system, an authorization message indicating that the transaction is authorized. In addition to transmitting, the authorization message, the account management system may automatically trigger an asynchronous loan origination process to create a loan data structure for a loan balance corresponding to the difference. The asynchronous loan origination process may occur independently from transmitting the authorization message to the point of sale system.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1A is a block diagram of an environment for an account management system, in accordance with an embodiment of the present disclosure.

FIG. 1B is a block diagram of the account management system, in accordance with an embodiment of the present disclosure.

FIG. 2 is a flow diagram for an asynchronous loan data structure origination process, in accordance with an embodiment of the present disclosure.

FIG. 3 is an example method for triggering the asynchronous loan origination process, in accordance with an embodiment of the present disclosure.

FIG. 4 is an example method for transmitting an authorization message, in accordance with an embodiment of the present disclosure.

FIG. 5 is an example method for an asynchronous loan data structure origination process, in accordance with an embodiment of the present disclosure.

FIG. 6 is an example method for defining a line of credit parameter for an account, in accordance with an embodiment of the present disclosure.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Aspects of the present disclosure relate to a system for asynchronously generating a loan data structure and/or a loan origination processing. In particular, the present disclosure relates to creating a loan data structure for a loan balance. The asynchronous loan data structure origination may be triggered during a transaction associated with an account (e.g., a checking account).

Accessing funds through a loan may involve multiple processing steps that may require days of processing. This processing may include qualifying a customer, originating the loan, generating disclosure documents, processing the loan, and/or transferring the funds to an account associated with the customer. In addition, the customer may desire to review the loan terms and conditions before borrowing the funds for payment. This process may cause timing delays and may not be possible when a customer is transacting with a merchant system and/or during a transaction with a merchant system.

To address such timing and computing inefficiencies, provided herein is an account management system configured to asynchronously trigger a loan data structure origination process. The account management system provides flexibility in defining and managing the loan data structure. The account management system also seamlessly triggers the asynchronous loan data structure origination process during transactions with a merchant point of sale system. This additionally provides payment flexibility for customers. For example, the customer has an option to pay and/or update a user account with a loan data structure. This may provide account funding and/or may provide flexible financing (e.g., multiple transactions over a period of time). This flexibility may also address different account scenarios. For example, when conducting a transaction, the customer may not want to withdraw or transfer funds from a saving account or a certificate of deposit (CD) to a checking account. In this case, account management system may generate a loan data structure and/or provide access to a line of credit associated with a checking account instead to make payments. The line of credit associated with the checking account may be based on preselected underwriting formulas (e.g., debt-to-income ratio). For example, a financial institution associated with the account management system may make an underwriting decision prior to extending the line of credit. Based on underwriting decision, the financial institution may offer the line of credit. Then, the line of credit may be associated with the checking account by the account management system.

In some aspects, the account management system has the advantage of authorization transactions even when the account has no funds (zero balance). The transaction may be authorized without delays caused by the loan origination process. By asynchronously triggering the loan data structure origination process independently from transmitting the authorization message, the present disclosure improves computer systems by allowing rapid loan data structure origination. Whereas previously, loan origination would take longer, aspects of the disclosure provide a process for loan data structure origination without delaying transactions occurring at point of sale systems. This loan data structure origination may occur without slowing down or creating a bottleneck in settlement systems and/or point of sale systems.

Various embodiments of these features will now be discussed with respect to the corresponding figures.

### System Overview and Function

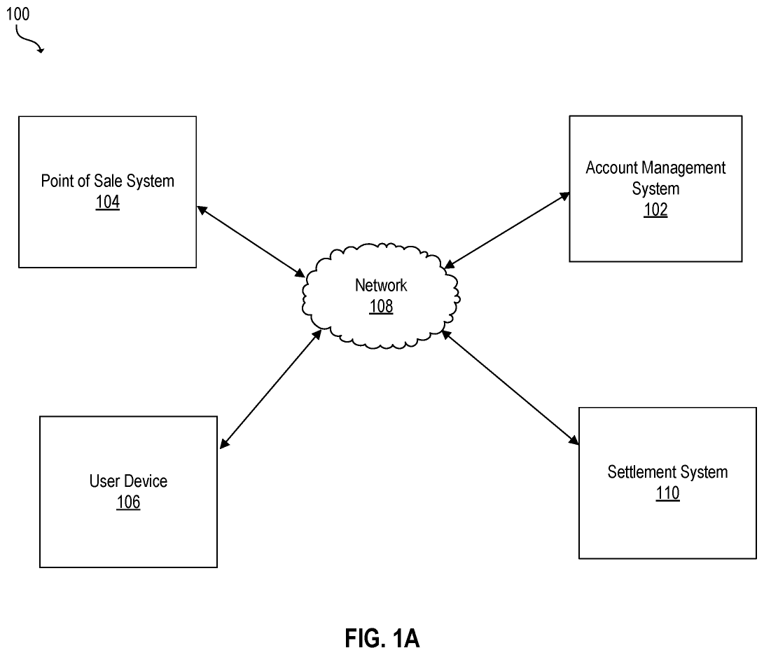

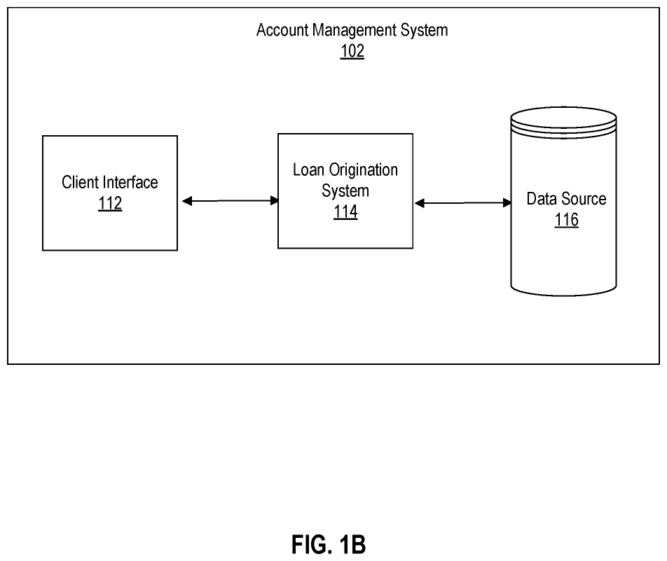

FIG. 1A is a block diagram of an environment 100 for an account management system 102, in accordance with an embodiment of the present disclosure. Environment 100 may include account management system 102, a point of sale (POS) system 104, a user device 106, a network 108, and a settlement system 110.

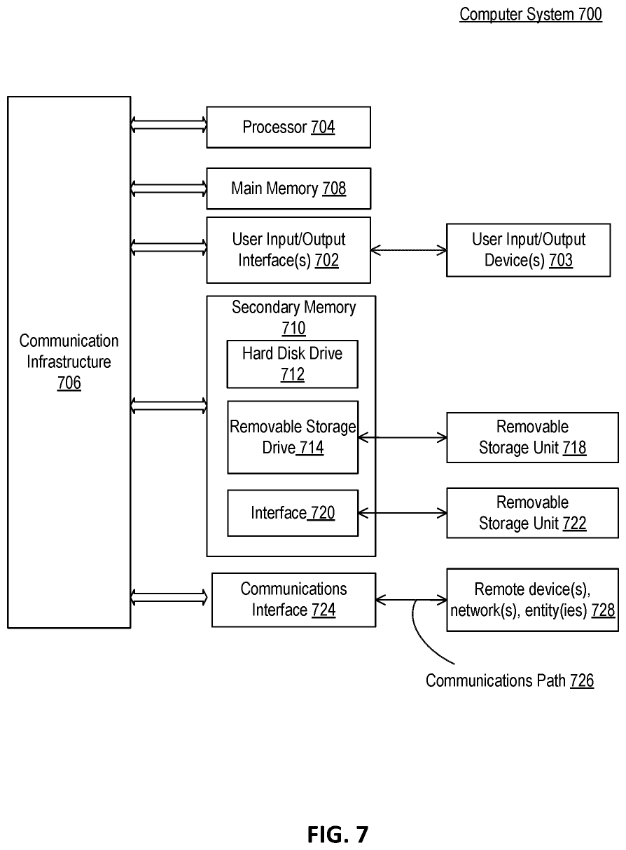

Account management system 102 may operate on one or more servers and/or databases. The servers may be a variety of centralized or decentralized computing devices. For example, a server may be grid-computing resources, a virtualized computing resource, peer-to-peer distributed computing devices, a mobile device, a laptop computer, a desktop computer, or a combination thereof. The servers may be centralized in a single room, distributed across different rooms, distributed across different geographic locations, or embedded within network 108. In some embodiments, account management system 102 may be implemented using computer system 700 described with reference to FIG. 7. Account management system 102 may provide a cluster computing platform or a cloud computing platform to trigger an asynchronous loan data structure origination process based on data provided by or acquired from POS system 104. For example, account management system 102 may receive transaction data from POS system 104. In some embodiments, this transaction data may be received from POS system 104 via settlement system 110. Account management system 102 may process the transaction data and/or trigger the asynchronous loan data structure origination process.

Account management system 102 may manage and/or associate an account with a user (e.g., a customer). Account management system 102 may also manage loan data structures corresponding to the account. For example, the account may be a checking account. Account management system 102 may also associate a line of credit parameter with the account. Account management system 102 may use this line of credit parameter when originating a loan data structure. For example, the line of credit parameter may correspond to an allowable loan value associated with the account. This may be a maximum value of the funds that the user can borrow. Account management system 102 may trigger multiple asynchronous loan processes for multiple loans up to the value of the line of credit parameter. Account management system 102 may trigger the multiple loans based on received transaction data. As described further below a transaction may refer to a transaction at a POS system 104. The transaction may also refer to a purchase at an online merchant, to a check payment, to an electronic check payment, an electronic bill payment, a wire transfer, an automated teller machine (ATM) withdrawal, or any other transaction that may processed using an account number and a routing number, a debit card, or a virtual debit card. Although FIG. 1A shows account management system 102 interacting with POS system 104, in some implementations, accounting management system may interact with an ATM machine, a system associated with a service provider, a bank system, a mortgage servicing entity, and the like. In addition, account management system 102 may perform fraud detection using machine learning models to detect fraudulent transactions and/or fraudulent attempts to create an account data structure.

In some aspects, account management system 102 may be connected to a lending system (e.g., a network of lending institutions) to provide and/or secure the funding for the loans. In some aspects, account management system 102 may correspond to a system of a checking account institution. Accounting management system 102 may provide services associated with the line of credit for the account (e.g., checking account) and/or may secure loan funding from other entities. In some aspects, repayment of the loan may be via direct deposits to the account. Account management system 102 may reroute a portion of the deposits to the lending institution based on the one or more loans data structure parameters.

POS system 104 may be a merchant system configured to facilitate in-person and/or online transactions. POS system 104 may be a computer system such as computer system 700 described with reference to FIG. 7. POS system 104 may include input I/O devices, one or more processors, and a memory such as computer readable media. In some aspects, POS system 104 may include one or more POS terminals. POS system 104 may be associated with a merchant. POS system 104 may determine a transaction value (e.g., total value of the merchandise or service provided) and acquire payment information from the customer. The payment information may include information that identifies an account (e.g., a checking account) that the customer wants to use for payment. For example, a user may present a card (e.g., a debit card) associated with the account for a payment in a transaction at POS system 104 associated with the merchant. Debit card data may be read by swiping the card at a POS terminal (e.g., at a card reader). POS system 104 may also receive the account information via a user interface of POS system 104.

After acquiring the account information, POS system 104 may send a request for authorizing a transaction to account management system 102 via settlement system 110. Account management system 102 may access settlement system 110 via an API command or call. POS system 104 may send transaction data with the request for authorization. The transaction data may include the transaction value and the information that identifies the account of the customer. For example, POS system 104 may send the total value of the merchandise that the customer wishes to purchase and the debit card data. In some embodiments, POS system 104 may handle transactions for goods and/or services.

In response to sending the request for an authorization message, POS system 104 may receive an authorization message or a rejection message from account management system 102. This may be received via settlement system 110. POS system 104 may output an approval or rejection on a display of the POS system 104. For example, POS system 104 may trigger a printing device to print a receipt indicating that the total value is paid. POS system 104 may also generate and transmit an electronic receipt to user device 106 and/or an email address.

As described herein, the customer may interact with account management system 102 via user device 106. User device 106 may be a computer system such as computer system 700 described with reference to FIG. 7. For example, user device 106 may be any variety of devices, such as a smart phone, a cellular phone, a personal digital assistant, a tablet computer, a notebook computer, a laptop computer, or a combination thereof used to access and to communicate with account management system 102. User device 106 may include one or more processors and/or memory. User device 106 may communicate with account management system 102 to create or modify an account data structure and/or account data.

The user may interact with and/or manipulate the account data structure in various ways. For example, the customer may send a request to open an account or associate a line of credit to an existing account. The request may include data identifying the customer. Account management system 102 may process the request and generate the account data structure. The account data structure may include one or more account parameters. The account parameters may include an account number, a number of a debit card associated with the account, a line of credit, and the like. The line of credit parameter is described further below with reference to FIG. 1B.

User device 106 may also receive account parameters from account management system 102. In some embodiments, user device 106 may be configured to download and/or install a software application to facilitate communications with account management system 102. For example, user device 106 may install the application from account management system 102 and/or an application marketplace or application exchange. User device 106 may communicate with account management system 102 via network 108.

In addition to creating the data structure, the customer may use user device 106 to transmit information identifying the account during an online transaction. In some embodiments, user device 106 may use a browser and/or communicate the information identifying the account via a website. This may occur, for example, when a customer uses user device 106 for online bill payments (e.g., utility providers) or online purchases. In some embodiments, the customer may enter a numeric value associated with the account into an account number field and a routing number field in a provider website.

As described herein, POS system 104 may interact with account management system 102 via settlement system 110. Settlement system 110 may handle electronic financial transactions and/or real-time payments. Settlement system 110 may include an automated clearing house (ACH), a card authorization system (CAS), a worldwide card authorization system (WWCAS), or other systems that handles financial transactions. The ACH may be an electronic funds transfer system that handles settlement of transactions to demand deposit accounts (DDAs). Card authorization system (CAS) may be an issuer system that authorizes point of sale transactions. Settlement system 110 may receive the request for authorization a transaction from POS system 104. Settlement system 110 may identify and transmit the request to account management system 102. After receiving a response from account management system 102, settlement system 110 may send a message granting authorization for the payment and/or denying the payment to POS system 104.

Account management system 102, POS system 104, user device 106, and/or settlement system 110 communicate via network 108. Network 108 may be a telecommunications network, such as a wired or wireless network. Network 108 can span and represent a variety of networks and network topologies. For example, network 108 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 108. Cable, Ethernet, digital subscriber line (DSL), fiber optic lines, fiber to the home (FTTH), and plain old telephone service (POTS) are examples of wired communication that may be included in network 108. Further, network 108 can traverse a number of topologies and distances. For example, network 108 can include a direct connection, personal area network (PAN), local area network (LAN), metropolitan area network (MAN), wide area network (WAN), or a combination thereof.

FIG. 1B is a block diagram of account management system 102, in accordance with an embodiment of the present disclosure. Account management system 102 may include a client interface 112, a loan origination system 114, and a data source 116.

Client interface 112 may be an interface for presenting and/or receiving information to/from a user (e.g., a customer, a merchant). The interface may be a communication interface such as a command window, a web browser, a display, and/or any other type of interface. Other software, hardware, and/or interfaces may be used to provide communication between the user and account management system 102. For example, client interface 112 may be a web portal that provides a web page or website to the user for viewing and interaction. The web portal may be located at a web address accessible via a web browser, and may be supported by one or more servers (e.g., computer system 700 as further described with reference to FIG. 7). The website may be a graphical user interface (GUI) provided by account management system 102 and/or via an application programing interface (API) provided by account management system 102. For example, user device 106 may communicate with client interface 112 to transmit the request to create the account data structure and submit information associated with the request. The request may include specific information that identifies the customer, for example, a social security number.

In some implementations, information associated with the account may be provided as a visual representation. The customer through the client interface 112 can display on a display of user device 106 an account activities statement, a list of loans, a value of the line of credit parameter, and the like. For example, client interface 112 may present the user with a loan tab (after authenticating the user and accessing the account associated with the user) such that the customer is provided with a list of open loans. The customer may manage the loans via client interface 112.

As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API R, a standard library such as C++, a JAVA API, and the like.

After receiving the request to create the account data structure, account management system 102 may acquire credit data associated with the customer. In some aspects, the request may include modifying the account data structure of an existing account (e.g., an enrollment in a line of credit program associated with the existing account). To retrieve the credit data (e.g., credit report), account management system 102 may connect to a system of a credit card bureau via network 108.

Based in part on the credit data, account management system 102 may define the line of credit parameter. In some aspects, the line of credit parameter may be based on preselected underwriting formulas (e.g., debt-to-income ratio). Other qualifying parameters may include employment and wage verification, account in good standing, user personal financial data, history of deposits, continued direct deposit, and other financial data.

In some aspects, account management system 102 may update the value of the line of credit parameter at regular intervals (e.g., monthly). For example, account management system 102 may pull the credit data from a credit card bureau system to detect any changes. Account management system 102 may increase or decrease the value of the line of credit based on the detected changes.

In addition, the value of the line of credit parameter may be updated after initiating a loan data structure with a particular loan value. The new value of the line of credit parameter may be reduced by the loan value. For example, the new value of the line of credit parameter is a previous value of the line of credit parameter minus the loan value. Account management system 102 may receive a fund deposit to the account or repayment of the loan. The value of the line of credit parameter may be updated in response to receiving a payment of the loan. For example, the updated value of the line of credit parameter may be the previous value of the line of credit parameter plus the repaid balance of the loan.

In addition to defining the line of credit parameter, account management system 102 may define one or more loan data parameters. The loan data parameters may correspond to a loan data structure. The one or more loan parameters may be specified inside a data structure (e.g., a JavaScript® Object Notation (JSON® object)). The parameters may be obtained by retrieving the data structure. Example loan parameters can include a loan rate, a loan term, a fees, and repayment methods and/or repayment frequency. In some aspects, the loan rate may be a buy now pay later (BNPL) rate, a low rate compared to payday loan or other rates, or a fixed rate.

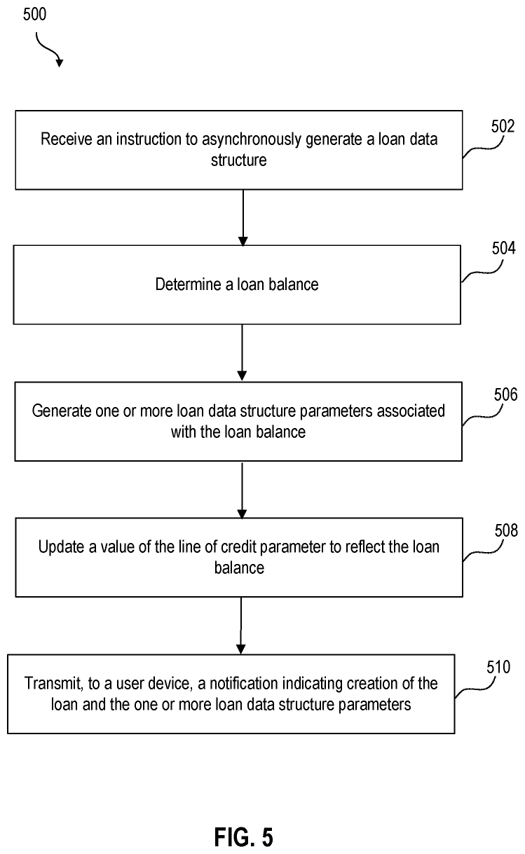

The one or more loan data structure parameters may be generated during the loan data structure origination process as described in relation to FIG. 5. The line of credit parameter and the one or more loan data structure parameters may be stored in data source 116 along with a customer profile. The customer profile can include personal information including the social security number, an account information, a username and password, an address, or a combination thereof.

Loan origination system 114 may originate a loan data structure as further described with reference to FIG. 5. Loan origination system 114 may be communicatively coupled to data source 116. Data source 116 may be, for example, a data lake. Although, only a single data source 116 is shown, account management system 102 may include any number of data sources. Loan origination system 114 may pull the loan data structure parameters from data source 116.

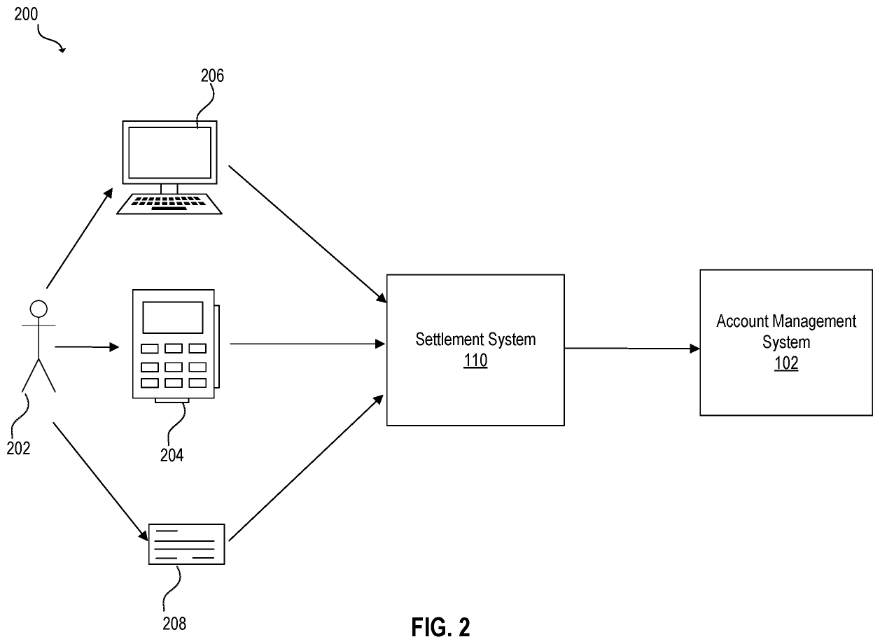

FIG. 2 is a flow diagram 200 for an asynchronous loan data structure origination process, in accordance with an embodiment of the present disclosure. A customer 202 may initiate a transaction. As described previously herein, the transaction may include a purchase with a merchant system. This may include in-person and/or online transactions. The transactions may also comprise one or more of: a debit card transaction, an electronic bill payment, an electronic check, an automated teller machine (ATM) withdrawal, and a wire transfer.

In some aspects, customer 202 may apply a debit card to a POS terminal 204. POS terminal 204 may be associated with POS system 104. Debit card data can be read by swiping the card in a slot of POS terminal 204 and/or inserting or tapping the card. Debit card data may be transferred via settlement system 110 to account management system 102 along with a transaction value.

In some aspects, customer 202 may provide account information for an online payment via a computer device 206. Customer 202 may input a routing number and an account number associated with the account. For example, customer 202 may enter the routing number and the account number to pay a bill associated with a service using a client interface of a service provider system. Settlement system 110 may collect this information and/or forward this information to account management system 102.

In some aspects, customer 202 may write a check 208 for a value to pay a bill or for other services such as rent or a mortgage payment. Check 208 may be processed by the service provider (e.g., deposited in a bank or other financial entity). The check is then processed via settlement system 110 (e.g., ACH network).

The following example illustrates an embodiment of the present disclosure.

Customer 202 may use a debit card associated with the account at POS terminal 204 for a purchase of items with a value of $60. POS terminal 204 transmits via settlement system 110 to account management system 102 a number of the debit card and a transaction value. Account management system 102 may compare the transaction value with an account balance. The account balance of the account associated with the purchase may be $50. The line of credit may be $100. Account management system 102 may determine the difference between the transaction and the account balance (e.g., $60-$50-$10). Account management system 102 compares the difference with a value of the line of credit (e.g., $10<$100). Account management system 102 may transmit an approval to POS terminal 204. Independently of transmitting the approval, account management system 102 may generate a loan data structure corresponding to the $10 amount. For example, account management system 102 may transmit an approval message in response to determining that the line of credit amount allows for the creation of a corresponding loan data structure. Account management system 102 may also update a value of the line of credit to $90 (e.g., $100-$10) to reflect the value of the loan.

### Methods of Operation

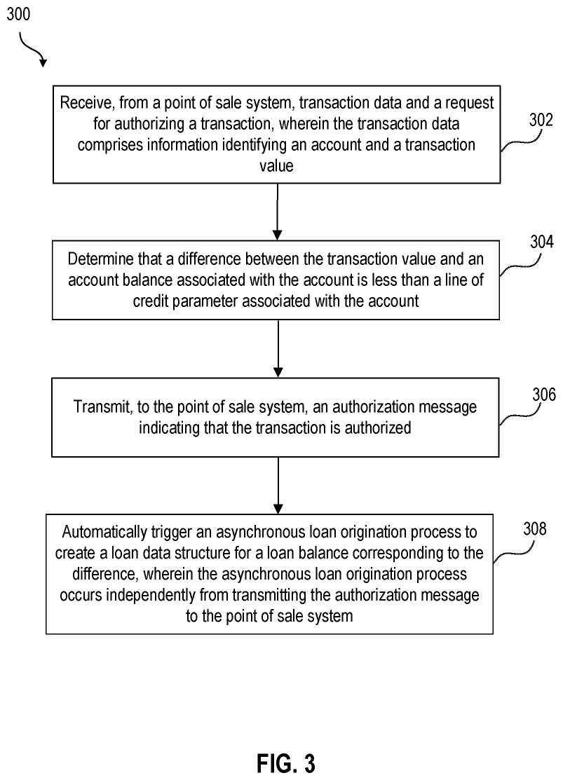

FIG. 3 is an example method 300 of operating account management system 102 for triggering the asynchronous loan origination process, in accordance with an embodiment of the present disclosure.

Method 300 may be performed as a series of steps by a computing unit such as a processor. For example, method 300 may be implemented by account management system 102 and/or computer system 700 of FIG. 7. Method 300 shall be described with reference to FIG. 1A, however, method 300 is not limited to that example embodiment.

At 302, account management system 102 may receive from POS system 104 transaction data and a request for authorizing a transaction. The transaction data comprises information identifying an account and a transaction value. In some aspects, the information identifying the account may include a routing number and an account number.

At 304, account management system 102 may determine that a difference between the transaction value and an account balance associated with the account is less than a line of credit parameter associated with the account.

At 306, account management system 102 may transmit to POS system 104 an authorization message indicating that the transaction is authorized or approved. POS system 104 may display an indication on a display of POS system 104 that indicates the approval of the transaction.

At 308, account management system 102 may automatically trigger an asynchronous loan origination process to create a loan data structure for a loan balance corresponding to the difference. The asynchronous loan origination process occurs independently from transmitting the authorization message to POS system 104. As described herein, 306 and/or 308 may occur in response to determining that the difference between the transaction value and the account balance associated with the account is less than the value of a line of credit parameter associated with the account. The automatic trigger of creating a loan data structure occurring independently from transmitting the authorization message to POS system 104 may provide faster transaction authorization and/or completion when interacting with POS system 104.

It is to be appreciated that not all steps may be needed to perform the disclosure provided herein. Further, some of the steps may be performed simultaneously, or in a different order than shown in FIG. 3, as will be understood be a person of ordinary skill in the art.

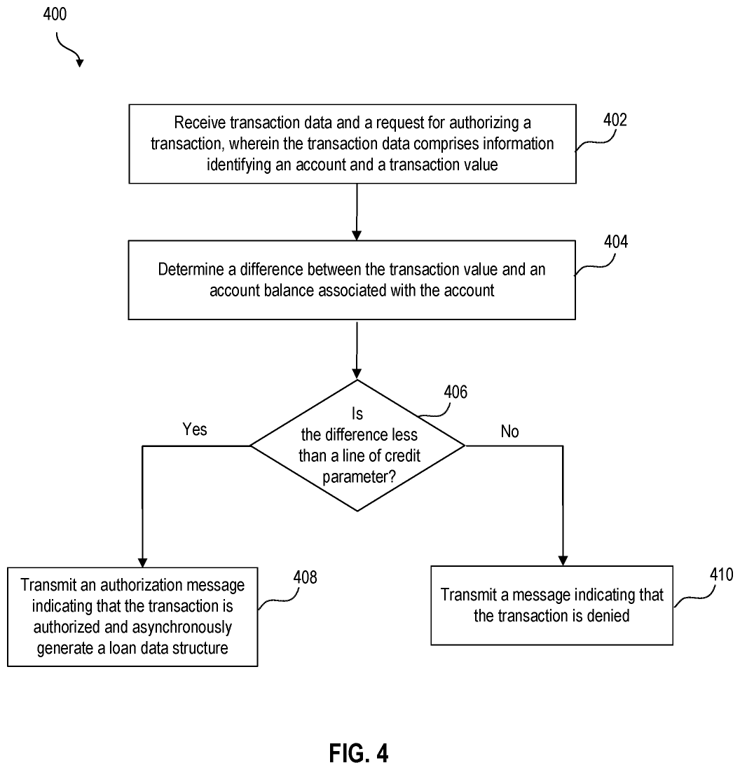

FIG. 4 is an example method 400 for transmitting an authorization message, in accordance with an embodiment of the present disclosure. Method 400 may be performed as a series of steps by a computing unit such as a processor. For example, method 400 may be implemented by account management system 102 and/or computer system 700 of FIG. 7. Method 400 shall be described with reference to FIG. 1A, however, method 400 is not limited to that example embodiment.

At 402, account management system 102 may receive transaction data and a request for authorizing a transaction. The transaction data may include information identifying an account and a transaction value. In some aspects, the transaction data may be received from the POS system 104 associated with a merchant via settlement system 110 (e.g., CAS).

At 404, account management system 102 may determine a difference between the transaction value and an account balance associated with the account. In addition, account management system 102 may pull data from data source 116 to determine the account balance associated with the user.

At 406, account management system 102 may make a determination whether the difference is less than a value of the line of credit parameter. In response to determining that the difference is less than the value of the line of credit parameter (i.e., resulting in a “yes” at 406), the process proceeds to 408. In response to determining that the difference is greater than the value of the line of credit parameter (i.e., resulting in a “no” at 406), the process proceeds to 410.

At 408, account management system 102 may generate and transmit an authorization message indicating that the transaction is authorized. The authorization message may include an authorization code. Account management system 102 may asynchronously generate a loan data structure. The asynchronous loan data structure origination process is further described with respect to FIG. 5.

In some aspects, one or more parameters of the account data structure may be updated. In some aspects, the updates and the asynchronous loan origination process are performed independently from transmitting the authorization message to POS system 104 such that the asynchronous loan origination process and the updates do not cause a delay at POS system 104. The updates may include updating a value of an account balance parameter of the account data structure to reflect at least a portion of the transaction value. For example, if the account balance is greater than zero but less than the transaction value, the loan balance may be less than the transaction value as some of the funds of the account may be used to complete the transaction.

In some aspects, account management system 102 may initiate a transfer of funds via an ACH network to a merchant account associated with the merchant. In some aspects, the funds for the loan balance are not deposited in the account associated with the user. For example, funds may be transmitted directly to the merchant account from the loan funding source. Account management system 102 may transmit an instruction to a loan funding source (e.g., a loan funding source system) to transfer funds to the merchant account without depositing the funds in the account associated with the user. This provides the advantage of minimizing time delays and avoiding duplicate transactions that may lead to computing inefficiencies. In some aspects, account management system 102 may initiate a transfer of the portion of the transaction value from the account of the user to a merchant account associated with the transaction. Account management system 102 may initiate the transfer of the loan balance to the merchant account. In some aspects, the transfer for the loan balance may be initiated from a loan funding source that may be a part of or different from account management system 102. Account management system 102 may transmit an instruction to a loan funding source system to transfer funds for the loan balance to the merchant account.

At 410, account management system 102 may generate and transmit a message indicating that the transaction is denied. The message may include an error code. Account management system 102 may transmit a notification to a user device 106 of the customers. The notification may inform the customer about that the transaction was denied and a reason with the denial (e.g., “line of credit exceeded”). The notification may be transmitted via a text message. In some aspects, the notification may be output on a display screen of user device 106. Account management system 102 may also transmit a message to POS system 104 indicating that the transaction has been denied.

It is to be appreciated that not all steps may be needed to perform the disclosure provided herein. Further, some of the steps may be performed simultaneously, or in a different order than shown in FIG. 4, as will be understood be a person of ordinary skill in the art.

FIG. 5 is an example method 500 for an asynchronous loan data structure origination process, in accordance with an embodiment of the present disclosure. Method 500 may be performed as a series of steps by a computing unit such as a processor. For example, method 500 may be implemented by loan origination system 114, account management system 102, and/or computer system 700 of FIG. 7. Method 500 shall be described with reference to FIGS. 1A and 1B, however, method 500 is not limited to that example embodiment.

At 502, loan origination system 114 may receive an instruction to asynchronously generate a loan data structure. The instruction may be received as a software instruction and/or a system command. The instruction and/or trigger may be received independently from transmitting the authorization message to the POS system 104.

At 504, loan origination system 114 may determine a loan balance. As described previously herein, loan origination system 114 may determine that the loan balance is equal to the difference between the transaction value and the account balance. In some aspects, a threshold balance parameter of the account data structure may indicate a desired minimum balance. The value of the threshold may be selected by the customer. The customer may desire to have keep a minimum balance and borrow the needed funds for the transaction. For example, the minimum balance may be set to $50. Assuming a current balance of $100 and a transaction value of $70, account management system 102 may trigger a loan origination process for a loan balance of $20.

At 506, loan origination system 114 may generate one or more loan data structure parameters associated with the loan balance. In some aspects, loan origination system 114 may define a value of the loan data structure parameter based on the loan value. For example, a first loan data structure parameter may be a loan term. For a loan balance below a first threshold, the parameter may be set to a preset period (e.g., one month). Another parameter may be associated with a loan rate. The loan rate may be determined based on the loan term, the loan balance, and one or more criteria associated with the customers. For example, the loan rate may be set to 0% if the loan term is less than one month and for qualified customers. This qualification may be based on account data corresponding to the particular account managed by account management system 102.

At 508, loan origination system 114 may update the value of the line of credit parameter to reflect the loan balance. For example, the updated value of the line of credit parameter may be equal to the previous value minus the loan balance.

At 510, loan origination system 114 may transmit a notification indicating creation of the loan and the one or more loan data structure parameters. Loan origination system 114 may transmit an alert to user device 106 with this information and/or alert the user to the creation of the loan. The notification may also include the one or more loan data structure parameters. For example, the notification may include the loan term and the payment due date. In some aspects, the notification may provide the customers with options for loan repayments. For example, the notification may provide the customer with an option to pay the loan over a one month period or two months period. Based on the received input from the customer, loan origination system 114 may update the one or more data structure parameters.

Options for loan repayments may include options for the customer to specify a different account for loan repayment. In addition, the customer may select to direct deposits to the loan repayment. In other examples, the customer may select to route a portion of direct deposits to loan repayment. For example, the customer may direct a preset amount (e.g., $50, $100) from each deposit toward the loan repayments. In other examples, the customer may select to a percentage amount (e.g., 10%) of each deposit. The one or more loan data structure parameters may be initialized based on the customer selection.

It is to be appreciated that not all steps may be needed to perform the disclosure provided herein. Further, some of the steps may be performed simultaneously, or in a different order than shown in FIG. 5, as will be understood be a person of ordinary skill in the art.

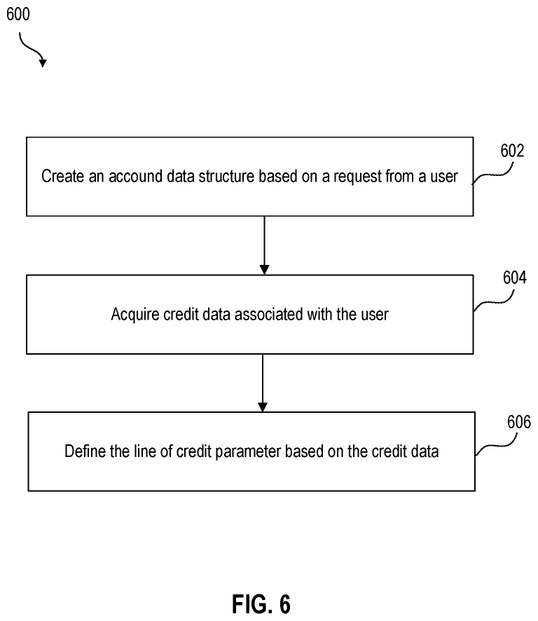

FIG. 6 is an example method 600 for defining a line of credit parameter for an account, in accordance with an embodiment of the present disclosure. Method 600 may be performed as a series of steps by a computing unit such as a processor. For example, method 600 may be implemented by account management system 102 and/or computer system 700 of FIG. 7. Method 600 shall be described with reference to FIG. 1A, however, method 600 is not limited to that example embodiment.

At 602, account management system 102 may create an account data structure based on a request from the customer. The account data structure may include a customer profile. The customer profile may be created based on information received from user device 106.

At 604, account management system 102 may acquire credit data associated with the customer. As described above, account management system 102 may connect, via network 108, to a credit bureau to pull the credit data. Account management system 102 may also pull information associated with the customer from data source 116.

At 606, account management system 102 may define the line of credit parameter based on the credit data. Account management system 102 may determine a value of the line of credit parameter by applying one or more underwriting formulas using the credit data and information available in the customer profile.

In some aspects, method 600 may be implemented before the transaction such that the customer is prequalified for the line of credit. Method 600 may be implemented when the user opens the account or when enrolling in a line of credit product associated with the account.

It is to be appreciated that not all steps may be needed to perform the disclosure provided herein. Further, some of the steps may be performed simultaneously, or in a different order than shown in FIG. 6, as will be understood be a person of ordinary skill in the art.

### Components of the System

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof. For example, the method steps of FIGS. 3, 4, 5, and 6 may be implemented via computer system 700.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
receiving, from a point of sale system, transaction data and a request for authorizing a transaction, wherein the transaction data comprises information identifying an account and a transaction value, and wherein the account is associated with a user;
determining that a difference between the transaction value and an account balance associated with the account is less than a value of a line of credit parameter associated with the account;
in response to the determining:
transmitting, to the point of sale system, an authorization message indicating that the transaction is authorized; and
automatically triggering an asynchronous loan origination process to create a loan data structure for a loan balance corresponding to the difference, wherein the asynchronous loan origination process occurs independently from transmitting the authorization message to the point of sale system.

2. The method of claim 1, further comprising:
creating an account data structure based on a request from the user;
acquiring credit data associated with the user; and
defining the line of credit parameter based on the credit data.

3. The method of claim 1, wherein the asynchronous loan origination process comprises:
generating one or more loan data structure parameters associated with the loan balance; and
updating the value of the line of credit parameter to reflect the loan balance.

4. The method of claim 3, further comprising:
transmitting, to a user device associated with the user, a notification indicating creation of the loan data structure, wherein the notification includes the one or more loan data structure parameters.

5. The method of claim 1, further comprising:
receiving, from the point of sale system via a card authorization system, the transaction data and the request for authorizing the transaction; and
processing a transfer of funds via an ACH network.

6. The method of claim 5, further comprising:
updating a value of the account balance to reflect at least a portion of the transaction value;
initiating a transfer of the at least a portion of the transaction value from the account to a merchant account associated with the transaction; and
initiating a transfer of the loan balance from a loan funding source to the merchant account associated with the transaction.

7. The method of claim 1, wherein the information identifying the account comprises a routing number and an account number.

8. The method of claim 1, further comprising:
transmitting an instruction, to a loan funding source system to transfer funds for the loan balance to a merchant account associated with the transaction without depositing the funds in the account associated with the user.

9. A system, comprising:
a memory; and
at least one processor coupled to the memory and configured to:
receive, from a point of sale system, transaction data and a request for authorizing a transaction, wherein the transaction data comprises information identifying an account and a transaction value, and wherein the account is associated with a user;
determine that a difference between the transaction value and an account balance associated with the account is less than a value of a line of credit parameter associated with the account;
in response to the determining:
transmit, to the point of sale system, an authorization message indicating that the transaction is authorized; and
automatically trigger an asynchronous loan origination process to create a loan data structure for a loan balance corresponding to the difference, wherein the asynchronous loan origination process occurs independently from transmitting the authorization message to the point of sale system.

10. The system of claim 9, wherein the at least one processor is further configured to:
create an account data structure based on a request from the user;
acquire credit data associated with the user; and
define the line of credit parameter based on the credit data.

11. The system of claim 9, wherein to originate the asynchronous loan, the at least one processor is further configured to:
generate one or more loan data structure parameters associated with the loan balance; and
update the value of the line of credit parameter to reflect the loan balance.

12. The system of claim 11, wherein the at least one processor is further configured to:
transmit, to a user device associated with the user, a notification indicating creation of the loan data structure, wherein the notification includes the one or more loan data structure parameters.

13. The system of claim 9, wherein the at least one processor is further configured to:
receive, from the point of sale system via a card authorization system, the transaction data and the request for authorizing the transaction; and
process a transfer of funds via an ACH network.

14. The system of claim 13, wherein the at least one processor is further configured to:
update a value of the account balance to reflect at least a portion of the transaction value;
initiate a transfer of the at least a portion of the transaction value from the account to a merchant account associated with the transaction; and
initiate a transfer of the loan balance from a loan funding source to the merchant account associated with the transaction.

15. The system of claim 9, wherein the information identifying the account comprises a routing number and an account number.

16. The system of claim 9, wherein the at least one processor is further configured to:
transmit an instruction, to a loan funding source system to transfer funds for the loan balance to a merchant account associated with the transaction without depositing the funds in the account associated with the user.

17. A non-transitory computer-readable device having instructions stored thereon that, when executed by at least one computing device, cause the at least one computing device to perform operations comprising:
receiving, from a point of sale system, transaction data and a request for authorizing a transaction, wherein the transaction data comprises information identifying an account and a transaction value, and wherein the account is associated with a user;
determining that a difference between the transaction value and an account balance associated with the account is less than a value of a line of credit parameter associated with the account;
in response to the determining:
transmitting, to the point of sale system, an authorization message indicating that the transaction is authorized; and
automatically triggering an asynchronous loan origination process to create a loan data structure for a loan balance corresponding to the difference, wherein the asynchronous loan origination process occurs independently from transmitting the authorization message to the point of sale system.

18. The non-transitory computer-readable of claim 17, the operations further comprising:
creating an account data structure based on a request from the user;
acquiring credit data associated with the user; and
defining the line of credit parameter based on the credit data.

19. The non-transitory computer-readable of claim 17, wherein the asynchronous loan origination process comprises:
generating one or more loan data structure parameters associated with the loan balance; and
updating the value of the line of credit parameter to reflect the loan balance.

20. The non-transitory computer-readable of claim 19, the operations further comprising:
transmitting, to a user device associated with the user, a notification indicating creation of the loan data structure, wherein the notification includes the one or more loan data structure parameters.
